(19) United States
(12) Patent Application Publication
(10) Pub. No.: US 2005/0216887 A1
(43) Pub. Date: Sep. 29, 2005

(54) Document development platform

(76) Inventors: William Robertson, Staten Island, NY (US); Dallas Jones, Santa Monica, CA (US); John Deslauriers, New York, NY (US)

Correspondence Address: Dara L. Onofrio, Esq.;c/o ONOFRIO LAW, Suite 1600, 1133 Broadway, New York, NY, 10010, US

(21) Appl. No.: 10/809,313

(22) Filed: Mar. 24, 2004

(51) Int. Cl. G06F 9/44

(52) U.S. Cl. 717/113; 717/111; 717/109

(57) ABSTRACT

A method and computer apparatus for creating, managing and using a document development system (“DDS”) is provided. The DDS includes a method for creating a document based upon a dialog and associated template (“DAT”). A DAT is a template associated or linked with a dialog box or form (“dialog”) such that a user can enter and/or select text in the dialog and the text will be displayed in a newly created document based upon the template. The DDS further includes a method for creating a DAT using a GUI and without the need for programming or coding the dialogs or the links between the templates and dialogs. The DDS further includes a method for managing DATs such that an organization can create, test and share DATs with the organization's end users.

### FIELD OF THE INVENTION

This invention relates generally to computer-created documents. In particular, the present invention relates to an improved method for creating and managing a document development system.

### BACKGROUND OF THE INVENTION

Many businesses have long required the creation of documents which adhere to a specific format, e.g., pleadings, patent & trademark applications, letters, etc. The creation of these documents requires much repetitive data entry and standardization of formatting. It was desirable to streamline the production of these documents, since the less time a user was involved with the mechanics of the document creation process, the more time they could spend on the actual content of the document, thereby increasing the user's overall productivity. When Microsoft DOS® was the principal desktop operating system this streamlining was typically done via the writing of simple keystroke macros. As the macro languages of the key word processing and other desktop applications were enhanced, so grew their complexity. They eventually evolved into programming development environments, much like Visual Basic and C++. However, a major limitation of these DOS-based macro languages was that there was no capability in the language to display a dialog. The user was typically presented with a question/prompt, which the user would then answer. A subsequent question/prompt would then be displayed, and this process would continue until all needed information was entered by the user in order to create the document.

With the advent of the Microsoft Windows® operating system, it was possible to design dialogs in these macro languages which would be displayed and filled in by the user. By contrast with the multiple prompts in DOS-based macro systems, this substantially improved the streamlining of the document creation process. Products were created to provide this solution to users. Some of these programs provided a simple yet powerful front-end for users to fill out dialogs displayed by the program, and the document creation process was streamlined. Users without extensive programming skills could purchase a product which provided dialogs for creating documents. The major drawback of this approach was that the creation of these dialogs via the Windows-based macro languages required true programming skills on the part of the person who created the dialog. Not many people had these skills. If the user wished to modify one of the standard dialogs which shipped with the product, they needed to be able to program in the macro programming language of the application, or hire someone to do so. In some cases, it was not possible at all to modify a dialog.

The need for users of these document creation applications to be able to customize the products by designing and creating custom dialogs became apparent and persists to the present day. In a Microsoft Word environment, for example, creating a custom dialog normally involves programming in Visual Basic for Applications (VBA) or Visual Basic (VB), adding individual controls to that dialog (form, as it is called in programming terms) and then setting all the individual properties associated with each of those controls. Controls are objects on a dialog which allow a user to either input data or select data which is displayed by or accessed through the object. Although setting the properties of those controls in VB or VBA does not involve programming, creating the overall dialog does, as well as setting any individual links or relationships between the controls.

Additionally, populating a control in VB or VBA always involves programming. That is, if a user desires to have a drop-down list display a series of choices for an end-user to select (such as a list of the months of the year), the user of VB or VBA, for example, would need to write code in order to list those choices (January, February, March, etc.).

There is thus a need for a document development system which allows users to create, use and manage custom dialogs and templates without the need to program the computer, i.e., write and compile code. These and other needs are satisfied by the present invention.

### SUMMARY OF THE INVENTION

In accordance with the principles of the present invention, a method and computer apparatus for creating, managing and using a document development system (“DDS”) is provided. The DDS includes a method for creating a document based upon a dialog and associated template (“DAT”). A DAT is a template associated or linked with a dialog box or form (“dialog”) such that a user can enter and/or select text in the dialog and the text will be displayed in a newly created document based upon the template. The DDS further includes a method for creating a DAT using a GUI and without the need for programming or coding the dialogs or the links between the templates and dialogs. The DDS further includes a method for managing DATs such that an organization can create, test and share DATs with the organization's end users.

The DDS is particularly useful to large organizations which produce many documents and which documents require standard structures, such as letters, fax cover sheets, pleadings and any document requiring automatic paragraph numbering. An example of such an organization is a law firm.

The present invention provides a method for creating DATs without the need for any programming on the part of the user. The invention further includes a method for making accessible and displaying user-created dialogs in native applications without the need for any programming on the part of the user. The invention further includes an improved method of creating and displaying templates during the creation process. The invention further includes an improved method of managing a DAT system comprising both DATs which are in use, i.e., published, and those which are being designed, i.e., a work in progress.

One aspect of the invention is a method of using a graphic user interface based document development system that includes designing a dialog without writing or compiling any computer code. The method also includes associating a template with the dialog without writing or compiling any computer code. The method also includes saving dialog and control properties to a database instead of writing computer code and compiling a dialog to a project file. The method also includes designing a template. The method further includes displaying a dialog by reading dialog and control properties from a database and using the properties to reconstruct the dialog. The method further includes enabling a user to enter data into a control or select data from a control to form control data which is then inserted into a document, based upon the template associated with the dialog, to generate a document. The method also includes providing the user, during the designing of a template, with a list of bookmarks which reflect the controls in the dialog so that the user can select one or more to insert into the template being designed. The method further includes inserting bookmark names at bookmarks in a template being designed to make the template easier to design, and includes deleting the bookmark names prior to saving the template.

Another aspect of the invention is a method of generating a document through a graphic user interface that includes reconstructing a dialog based upon dialog and control properties read from a database and displaying the dialog. The method further includes entering data into at least one control of the dialog to form control data and inserting the control data into a document, based on a template which has been associated to the dialog, at a position marked by a bookmark, where the bookmark corresponds to a control in the dialog. In this aspect of the invention, as in all aspects, the dialog is not compiled as computer code and saved in a project file.

Another aspect of the invention is a graphic user interface based document development system which includes a graphic user interface based dialog designer configured to: enable a user to design a dialog; enable a user to configure dialog and control properties; enable a user to associate at least one template with the dialog without writing or compiling computer code; and save the dialog and control properties to a database. The DDS is further configured to enable a user to design a dialog, configure dialog and control properties and associate at least one template to the dialog, all without the user needing to write or compile computer code.

The DDS may be further configured to include a graphic user interface based template administrator configured to enable a user to design a template by adding at least one bookmark to the template where the bookmark corresponds to a control in the dialog. The template administrator may further be configured to read control names contained in the dialog and a template name of the template associated to the dialog from a database; open the template in a native application; display a list of bookmarks corresponding to the control names; and enable the user to insert at least one bookmark into the template. The template administrator may be further configured to insert a bookmark name into the template at the position of each bookmark; and delete each bookmark name from the template prior to saving the template.

The DDS may be further configured to include a document generator configured to: read dialog and control properties from the database; construct a dialog from the dialog and control properties; display the dialog; enable a user to enter information into or select information from controls contained in the dialog to form control data; command a native application to create a document based on the template associated to the dialog and insert the control data into the document at bookmark positions, where each bookmark corresponds to a control in the dialog.

Another aspect of the invention is a program storage device or signals readable by a computer, tangibly embodying instructions executable by the computer to perform a method of enabling a user to operate a graphic user interface based document development system, where the method includes: enabling the user to design a dialog; enabling the user to associate a template with the dialog; saving dialog and control properties to a database; and enabling a user to design the template. The design of the dialog and the association of a template to the dialog is achieved without the user writing or compiling computer code

Another aspect of the invention is a program storage device or signals readable by a computer, tangibly embodying instructions executable by the computer to perform a method for enabling a user to generate a document through a graphic user interface, where the method includes: reading dialog and control properties from a database; constructing a dialog based on the dialog and control properties; displaying the dialog; enabling the user to enter data into at least one control of the dialog to form control data; and enabling the user to insert the control data into a document based on a template which has been associated to the dialog at a position marked by a bookmark.

Additional advantages and novel features of the invention will be set forth in part in the description which follows and in part will become apparent to those skilled in the art upon examination of the following or may be learned by practice of the invention. The advantages of the present invention may be realized and attained by means of instrumentalities and combinations particularly pointed out in the appended claims.

### BRIEF DESCRIPTION OF THE DRAWINGS

Features and advantages of the present invention will become apparent to those skilled in the art from the following description with reference to the drawings, in which:

FIG. 1 illustrates a block diagram of an exemplary computer system 100 in which an embodiment of the present invention may be implemented;

FIG. 2 illustrates a block diagram of an exemplary network in which an embodiment of the present invention may be implemented.

FIG. 3 illustrates a block diagram of an exemplary embodiment of a software architecture 300 of the document development system 120 as shown in FIG. 1.

FIG. 4 illustrates a flow diagram of an exemplary method 400 for implementing the principles of the software architecture 300 as shown in FIG. 3;

FIG. 5 illustrates a flow diagram of an exemplary method 500 for implementing the principles of the software architecture of the dialog designer, as shown in FIG. 3;

FIG. 6 illustrates a flow diagram of an exemplary method 600 for implementing the principles of the software architecture of the template administrator, as shown in FIG. 3; and

FIG. 7 illustrates a flow diagram of an exemplary method 700 for implementing the principles of the software architecture of the document generator, as shown in FIG. 3.

### DETAILED DESCRIPTION OF PREFERRED EMBODIMENTS

For simplicity and illustrative purposes, the principles of the present invention are described by referring mainly to an exemplary embodiment thereof. Although the preferred embodiment of the invention may be practiced as a Microsoft Word® dialog and associated template authoring and management tool, and document generating tool, one of ordinary skill in the art will readily recognize that the same principles are equally applicable to, and can be implemented in, any type of Windows-based program which makes use of documents, e.g., Microsoft Excel® or Microsoft PowerPoint® and that any such variation would be within such modifications that do not depart from the true spirit and scope of the present invention.

In accordance with the principles of the present invention, a document development system (“DDS”) is used to quickly and easily design an associated dialog and template (“DAT”) system without the user having to have any true programming skills and to use the DAT system to generate a document in a native application such as Microsoft Word. Prior to the present invention, if the user desired to create a DAT, the user would have had to first code the dialog in a computer programming language, program the links between the dialog and the template and then compile the program into machine readable form. This required an individual with programming skills.

For the sake of clarity and simplicity the following description of the DDS is structured according to a three task framework: dialog design, template design, and document generation.

In particular, the DDS may be presented to a user as a standalone program executing on a computer system or, more preferably, as an integral part of a native application modified to allow access to the DDS from a menu therein. By “native application” we mean any program executing on a computer running on top of the Microsoft Windows operating system environment which makes use of documents. Examples of such programs are Microsoft Word, Excel and PowerPoint.

The DDS may be presented on a single computer, or, more preferably, as part of a network of computers, over which a person administrator can make available DATs which have been created for an organization.

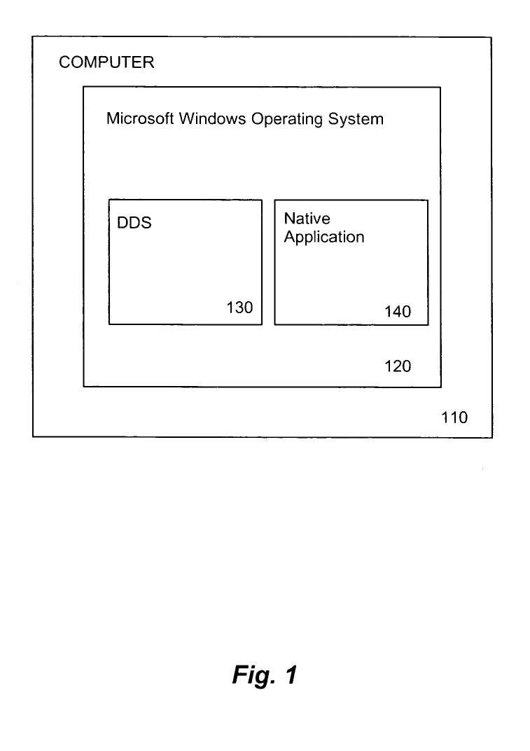

FIG. 1 illustrates a block diagram of an exemplary computer system 100 in which an embodiment of the present invention may be implemented. As shown in FIG. 1, the computer system 100 includes at least a computer 110, a Microsoft Windows Operating System 120, a DDS 130 and a native application 140. The computer 110 may be configured to serve as an execution platform for the operating system, the DDS 130 and the native application 140. The computer 110 may be implemented by a personal computer, a laptop, a workstation, and the like.

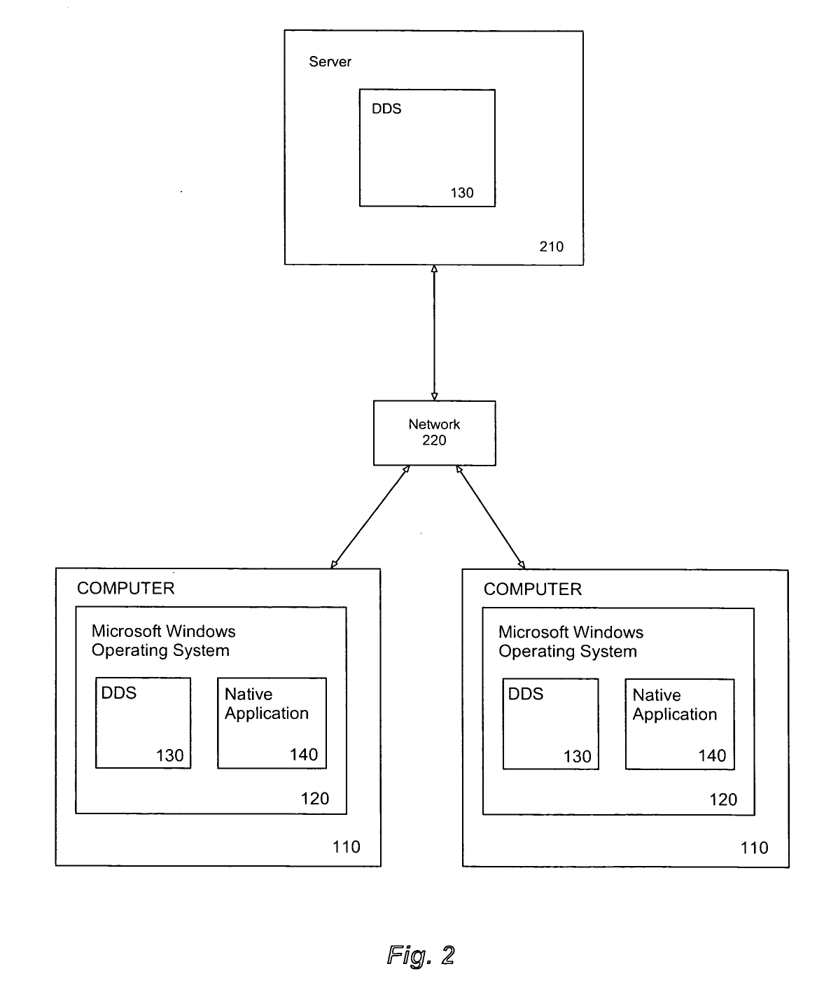

FIG. 2 illustrates a block diagram of an exemplary computer network in which an embodiment of the present invention may be implemented. As shown in FIG. 2, the computer network includes at least a server 210, and one or more computers 110. The server 210 may be interfaced with the computers 110 through a network. The server 210 may be configured to include a copy of the DDS 130. The server 210 may be configured to provide computing services (i.e., application software, data storage, input/output service, etc.) to the computers 110. The computers 110 may be configured to provide a user with access to the computing services of the server 210 at a remote location. The computers 110 may be implemented as terminals, personal computers, workstations and the like. The computers 110 may be configured to execute the functionality of the DDS 130.

The network 220 may be configured to provide a communication channel between the server 210 and the computers 110. The network 220 may be implemented as a local area network, a wide area network, a wireless network, and the like.

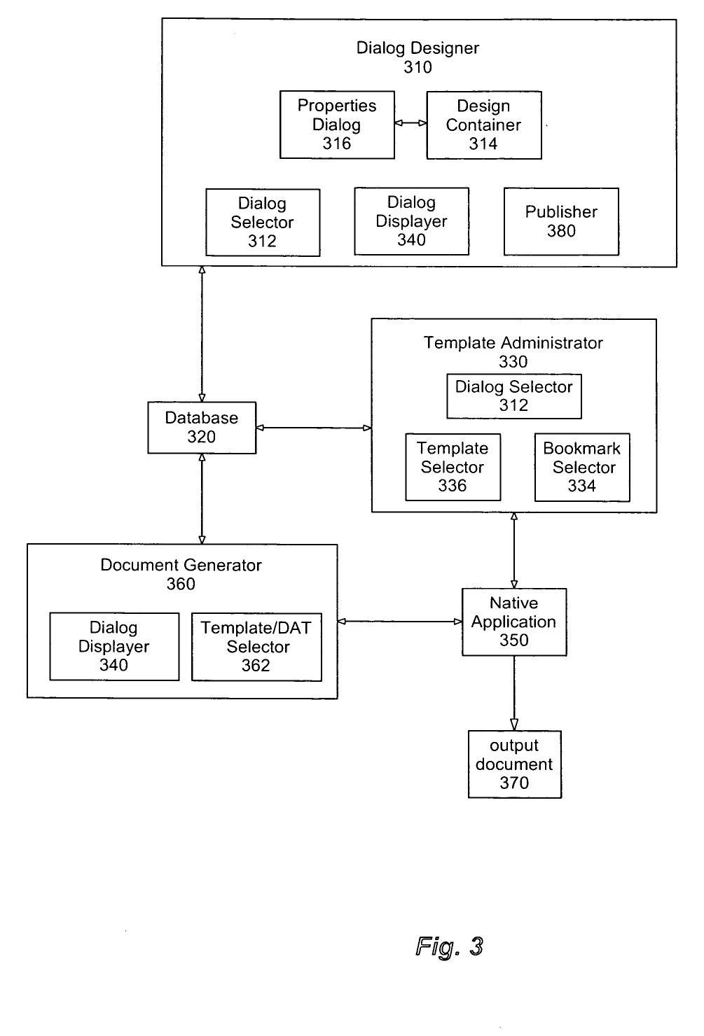

FIG. 3 illustrates a block diagram of an exemplary embodiment of a software architecture 300 for the DDS 120 shown in FIG. 1. The software architecture 300 includes at least a dialog designer 310, a database 320, a template administrator 330, a dialog displayer 340, a native application 350, a document generator 360 and an output document 370.

The dialog designer 310 is the module which is used to accomplish the first above-stated task of the DDS, i.e., dialog design. The user of the dialog designer 310 creates or modifies a dialog, which dialog is intended to be used by an end-user to create a document based on the dialog and an associated template.

The dialog designer 310 may be configured to enable the user to create a dialog and associate it with one or more templates through a GUI, without programming. The dialog designer 310 may be configured to provide a dialog design container 314 (“design container”) and a properties dialog 316.

The dialog designer 310 may be further configured to provide a dialog selector 312, in which the user can, through a GUI, select to design a new dialog or to open and continue designing a dialog which has been previously saved to a storage device. This dialog selector 312 may be provided in any suitable manner, e.g., as a menu in the properties dialog 316 or as a toolbar or combination thereof.

The dialog designer 310 may be further configured such that the user can use a GUI to select one or more controls to insert into the design container 314. This selection may be provided in any suitable manner, e.g., in the form of a menu in the properties dialog 316 or as a toolbar of icons which can be dragged and dropped individually or in groups into the design container 314.

The properties dialog 316 may be configured to be context sensitive, depending upon what object in the design container 314 the user selects. Using a pointing device, for example, the user may select a control or the dialog itself in the design container 314. If the user selects a control in the design container 314, the properties dialog 316 will display a list of each property, and its corresponding value, of the selected control. If the user selects the dialog itself in the design container 314, the properties dialog 316 displays a list of each property, and its corresponding value, of the dialog.

The dialog designer 310 may be further configured to accept user input through a GUI to change the size, position and any other properties of the dialog and each control in the design container 314. With respect to size and position properties, as those skilled in the art will be familiar, the user input may include dragging and dropping objects or the borders of objects with a pointing device or with the keyboard. The design container 314 may be configured such that if the user changes the size and position of the design container 314, the size and position properties of the dialog being designed are changed to the same values.

In addition to dragging and dropping, the user input may be in the form of editing size, position and any other properties from within the properties dialog 316. As stated above, when the user selects a control in the design container 314, the properties dialog 316 will display a list of each property of the selected control with the property's corresponding value. Similarly, when the user selects the dialog in the design container 314, the properties dialog 316 displays a list of each property of the dialog with the property's corresponding value. To change a property of an object selected in the design container 314, the user would edit the value of the property in the property dialog. Those skilled in the art will understand that editing a value of a property in the property dialog may take the form of inserting or modifying text, making a selection from a menu, e.g, a drop-down menu, or any other commonly used GUI method for making changes or selections.

Thus, for example, if the user has selected a control in the design container 314, the properties dialog 316 will present a list of properties, and corresponding values, of the control. The user can then directly change the values of the properties of the selected control in the properties dialog 316. The selected control will change in response to any changes made to the property value in the properties dialog 316.

An essential aspect of the present invention is that a dialog designed and used according to the present invention must be associated with at least one template. This association is a property of the dialog, and, in a preferred embodiment, it may be set or changed by selecting a template from a drop-down menu, or from a pop-up directory tree dialog. In order to associate a template to a dialog, the template must already exist, i.e., it must have been created prior to making the association. In one embodiment, the template is created in the native application 350 and saved. It is then available to be associated to a dialog. In another embodiment, the template may be created by the template administrator 330 and saved, making it available to be associated to a dialog. The method of creating the template is not critical to the present invention.

Another essential aspect of the present invention is that the dialog and its association with a template are not programmed and compiled as they would have been prior to the present invention. Therefore, the designer of a dialog according to the principles of the present invention does not have to know how to program a computer in order to achieve the design of a dialog and its association with a template. This is also an advantage of the present invention, because the user does not need to know how to program or code in order to customize the DDS to meet the user's requirements. To achieve this, the dialog designer 310 may be configured to save the properties of the dialog and its controls to a database 320, so that the dialog can be reconstructed when it is required, e.g., for further editing or for use in creating documents pursuant to the principles of the present invention. In this configuration, a file containing programming language source code which defines the dialog designed by the user is not compiled and created. Instead, when the dialog needs to be displayed, a dialog displayer 340 reads the dialog and control properties from the database 320 and uses those properties to construct a dialog on-the-fly and display the dialog as if it had been coded and saved in a compiled project file in a programming language such as VB or VBA. One method for accomplishing this is to read the dialog and control properties from the database 320, display a dialog, create an instance of each control at runtime, and set the appropriate properties as per the data read from the database 320.

Those skilled in the art will recognize that the type of database 320 used to store the dialog and control properties is not critical to the invention. It is preferred, however, to use a structured query language (“SQL”) database 320 or a Microsoft Access® database 320.

The dialog designer 310 may be further configured to have a “preview control” which, when selected by the user calls the dialog displayer 340 which then displays the dialog as described above.

In some cases, as may be practiced by large organizations, dialogs and their associated templates may be designed centrally within the organization, and may be tested prior to being published for use by all or a subset of the organization's end-users. The ability to publish a dialog may be limited to one or more persons or administrators, so that order and control over the dialogs are maintained. Prior to publication, the dialog and its associated template are available only to the administrator. In a preferred embodiment of the invention, a dialog is not made available to end-users when the administrator saves the dialog and control properties to the database 320. Instead, when the administrator has determined that a dialog should be published, the administrator must affirmatively do so by selecting a “publish” control, the publisher 380, which control may be provided to the administrator in the properties dialog 316, or other suitable dialog. By selecting the “publish” control the publisher 380 causes the following to take place: (a) any and all templates associated to the dialog being published are moved out of the administrator's temporary work in progress (“WIP”) directory to the shared templates directory accessible by all users in the organization; and (b) all dialog and control properties data is moved out of a temporary set of WIP tables in the database 320 to a set of public tables accessible by all users in the organization.

The template administrator 330 is the module which is used to accomplish the second above-stated task of the DDS, i.e., template design. The user of the template administrator 330 designs a template which has been associated to a dialog in the dialog designer 310. Once design is completed, the template can be used by an end user to create a document based upon the template and the dialog to which it is associated.

The template administrator 330 may be configured to provide the user with a GUI for designing a template associated with a dialog. The template administrator 330 preferably displays a dialog selector 312, containing a list of dialogs for user selection.

Upon receipt of a dialog selection, the template administrator 330 may be configured to read the names of the controls contained by the dialog from the database 320. The template administrator 330 may be preferably configured to display a list of bookmarks corresponding to the control names in a bookmark selector 334. Each bookmark preferably has the same name as the control to which it relates, to make the selection and use of the bookmarks more intuitive for the user and to avoid the need for any programming. A bookmark is a placeholder in a document or template which can be used by a user or a computer program to navigate to a specific position in a document or template.

In addition, upon receipt of a selection from the dialog selector 312, the template administrator 330 may be further configured to read the name of a template associated with the dialog from the database 320, and the template administrator 330 may be configured to command the native application 350 to open the template. The name of the template associated with the dialog is saved in the database 320 by the dialog designer 310.

In a preferred embodiment, a dialog may have more than one template associated to it. In this embodiment, the template administrator 330 may command the native application 350 to open one template associated with the selected dialog, and the template administrator 330 may be configured to display a template selector 336 which lists all of the templates associated to the dialog. The template administrator 330 may be configured to accept user selection of one of the listed templates and to command the native application 350 to close the displayed template and to display the user selected template.

The template administrator 330 may be further configured to accept user selection of one or more bookmarks and to insert each bookmark into the template. In a preferred embodiment the template administrator 330 may be configured to enable the insertion of each bookmark multiple times into the template.

In the case of a native application 350, such as Microsoft Word, which does not display a bookmark's name at the position of a bookmark, the template administrator 330 may be configured to insert the name of each bookmark in the template at the position of each bookmark. This has the added benefit of making the template design more intuitive by making it easier for the user to visualize the positions of the bookmarks in the template. In this configuration, when the user indicates through a menu selection or by clicking on a control that the template should be saved, the template administrator 330 deletes the bookmark names, but not the bookmarks, so that the template is saved with only the bookmarks.

Once both the dialog and template have been designed and associated forming a DAT, they are ready to be used to generate documents.

The document generator 360 is the module which is used to accomplish the third above-stated task of the DDS, i.e., document generation. The user of the document generator 360 creates a document using the DAT.

The document generator 360 may be started as a standalone program, or, more preferably, the document generator 360 may be called from the native application 350 by user selection of a menu or toolbar, for example.

The document generator 360 may, in a preferable embodiment, be configured to display a template/DAT selector 362, containing a list, or the like, of both templates and DATs for selection by the user. The template/DAT selector 362 may further be configured to accept a user selection of a template or a DAT. In the context of the template/DAT generator, a “template” is a template which has not been associated with a dialog of the present invention to form part of a DAT. Alternatively, the document generator 360, may be configured to display a DAT selector which only displays DATs for selection.

If the document generator 360 is configured to display a template/DAT selector 362 and the user selects a template, but not a DAT, a document based upon the template is opened in the native application 350, and the document generator 360 closes. The user may then edit the document in the native application 350. If the user selects a DAT, the template/DAT selector 362 may be further configured to pass the DAT selection to the document generator 360.

Upon receipt of the DAT selection, the document generator 360 reads the corresponding dialog and control properties from the database 320. The document generator 360 may be further configured to forward the dialog and control properties to a dialog displayer 340. Alternatively, the document generator 360 may be configured to pass the DAT selection to the dialog displayer 340 and the dialog displayer 340 may be configured to read the corresponding dialog and control properties from the database 320. Those skilled in the art will appreciate that regardless of which of these configurations is used, the end result is the same: the dialog displayer 340 is in possession of the dialog and control properties.

The dialog displayer 340 may be configured to display a dialog which is defined by the dialog and control properties. The dialog displayer 340 may be further configured to accept user interaction with the dialog. User interaction with the dialog is intended to achieve multiple purposes, including, but not limited to: insertion of text or other data into a control for the purpose of this text or other data being inserted into a document at a bookmark position for display in a generated document; selection of text or other data to be inserted into a document at a bookmark position for display in a generated document; selection of a template to be used by the dialog for inserting text or other data into a document at bookmark positions for display in a generated document based on that template Information which has been inserted into a control, or selected within a control, or which is contained in a label control is referred to herein as “control data”.

When the user is finished interacting with the dialog, the user can, for example, click on an “OK” control. The dialog displayer 340 may be configured such that upon receipt of this indication that the user is finished interacting with the dialog, the dialog displayer 340 forwards the control data to the document generator 360.

When the document generator 360 receives the control data from the dialog displayer 340, the document generator 360 may be configured to command the native application 350 to create a document, based upon the template which forms a part of the DAT, in the native application 350. The document generator 360 may be further configured to insert the control data into the document at the appropriate bookmark locations, i.e., for any given control data, the appropriate bookmark is the bookmark with the same name as the control. The document generator 360 may be configured to accomplish this by searching for bookmarks in the open document, matching each bookmark to the name of a control in the dialog, inserting the control data for the appropriate dialog control into the document at the bookmark position, and deleting the bookmark. The resulting document contains the control data structured and formatted according to the template, as designed by the user in the template administrator 330.

Once the document has been generated by the document generator 360, the user may interact with the native application 350 in the usual manner to output the document in any form of which the native application 350 is capable.

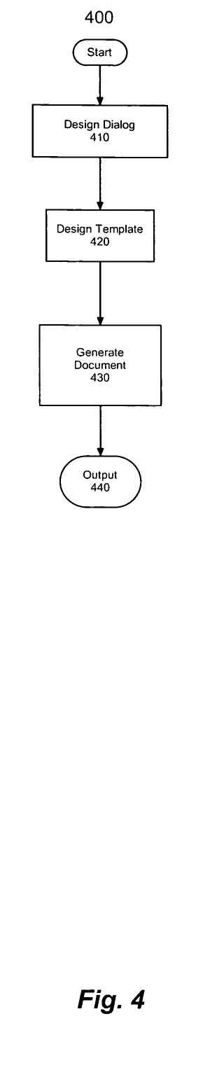

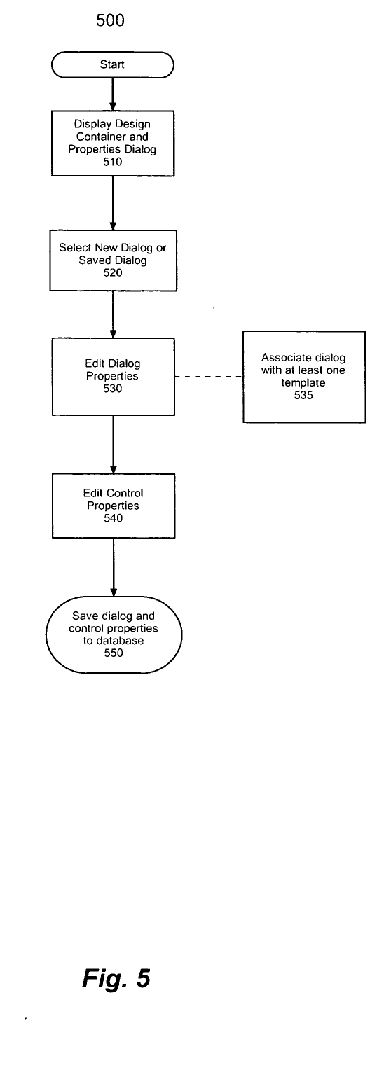

FIG. 4 illustrates a flow diagram of an exemplary method 400 for implementing the principles of the software architecture 300 as shown in FIG. 3. FIG. 4 is simplified to illustrate the three major tasks of the DDS and serves as a framework in which to understand the functions of the various modules of the DDS. Each of the steps described in FIG. 4 is described in greater detail in the descriptions of FIGS. 5-7. FIGS. 5-7 taken together provide a detailed flow diagram of an exemplary method for implementing the principles of the software architecture 300 as shown in FIG. 3.

In step 410, the user designs a dialog with the dialog designer 310. The user inserts controls into the dialog, sets control properties, and sets dialog properties, including associating the dialog with an existing template. In step 410, The dialog designer 310 may be configured to save the dialog and control properties to a database 320. A preferred method of implementing the principles of the software architecture of the dialog designer 310 is more fully described in the description of FIG. 5.

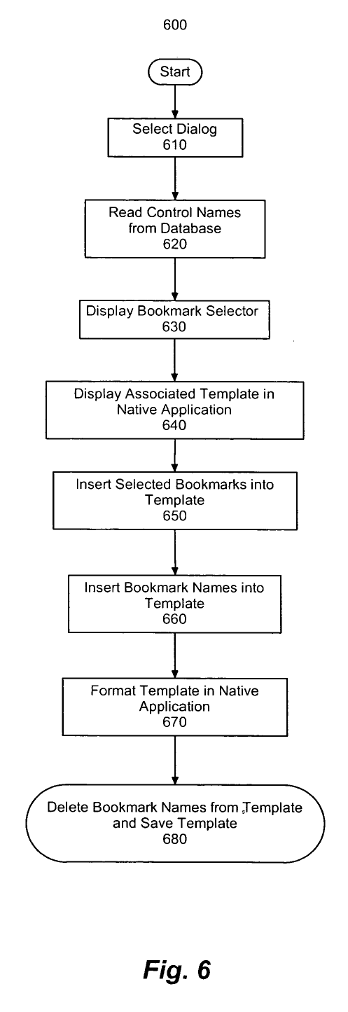

In step 420, the user designs a template with the template administrator 330. The user identifies the dialog on which to base the template to be designed. The control names are read from the database 320 in which they were saved in step 410. The name of the template associated with the dialog is read from the database 320 and opened in the native application 350. A list of bookmarks is presented to the user and the user designs the appropriate template by inserting bookmarks into desired positions in the template and otherwise formatting the template in the native application 350. A preferred method of implementing the principles of the software architecture of the template administrator 330 is more fully described in the description of FIG. 6.

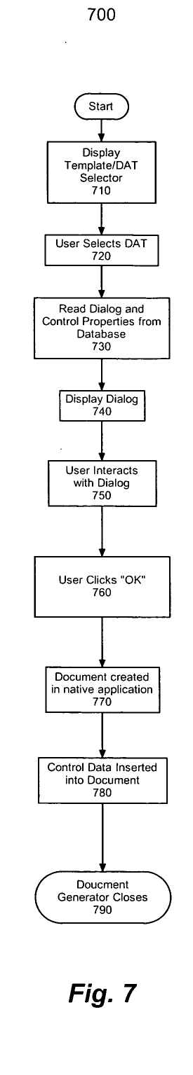

In step 440, a user generates a document using the DAT. The user enters text or other data into the dialog, selects text or other data, and/or selects the appropriate template to be used with the dialog. The text or other data is inserted into a document created in a native application 350 based upon the appropriate template, i.e., the template associated with the dialog, at locations specified by the bookmarks in the template. A preferred method of implementing the principles of the software architecture of the document generator 360 is more fully described in the description of FIG. 7.

FIG. 5 illustrates a flow diagram of an exemplary method 500 for implementing the principles of the software architecture of the dialog designer 310, as shown in FIG. 3. In step 510 the dialog designer 310 displays a design container 314 and a properties dialog 316.

In step 520 the properties dialog 316 presents the user with a menu from which the user can choose to design a new dialog or to continue to design a saved dialog. This can also be accomplished by presenting the user with a toolbar from which to select an action. If the user selects “file, new”, for example, then a blank dialog is displayed in the design container 314. In a preferred embodiment, the new dialog may contain default controls, such as “OK”, “Cancel”, or any other control. If the user selects “file, open”, for example, the user is presented with a list or menu of saved dialogs for selection. When the user selects a dialog, the selected dialog is displayed in the design container 314.

Generally, in step 530 the user edits the dialog properties and in step 540 the user edits the control properties. As used herein, “dialog properties” refers to those properties of a dialog which are not associated with the properties of individual controls contained in the dialog, and “control properties” refers to the properties of individual controls contained in the dialog.

More specifically, in step 530 the user edits the dialog properties, which can include name, size and position, associated template(s) and document type, e.g., letter, fax, memo, pleading, verification, etc. In addition, the user edits the dialog by adding or deleting controls. Controls can include any standard dialog controls such checkboxes, comboboxes, labels, listboxes, textboxes, etc., as well as any custom controls.

Further in step 530, and as described above, the user adds controls using a GUI to select and insert them from a menu contained in a properties dialog 316 or by dragging and dropping them from a toolbar. The user may delete controls by selecting them and then by selecting delete or cut from a menu, from the keyboard or from a toolbar.

Further in step 530, and as described above, the user may edit size and position of the dialog, using a GUI to drag and drop the design container 314, or its boundaries. The user can edit all properties of the dialog, including size and position. using a GUI to change the values of the control properties in a context sensitive properties dialog 316. A “context sensitive” properties dialog 316 means that if the user has selected the dialog, the properties dialog 316 will display the properties, and the associated values, of the dialog.

In step 535, the user selects a template through a GUI to associate with the dialog. In a preferred embodiment, a dialog may have more than one template associated with it. In a preferred embodiment the template or templates to be associated with the dialog may be selected from a drop-down list or a pop-up directory tree menu which is presented to the user when the user selects the “associated template” property value in the properties dialog 316.

More specifically, in step 540 the user edits the control properties, which properties may be different for different controls. For example, a listbox may the have the properties: name; left; top; width; height; visible; enabled; tabindex; sorted; and listlink, etc., while a label control may have the properties: name; left; top; width; height; visible; enabled; tabindex; alignment; and bold, etc.

As described above, the user may edit size and position of the controls using a GUI to drag and drop a control, or its boundaries. Also as described above, the user may edit any property of a control, including size and position using a GUI to change the value of the property in the properties dialog 316.

Those skilled in the art will appreciate and understand that the user can perform step 540 for any given control anytime after the control has been added to the design container 314 in step 530, and the user does not need to finish adding controls in step 530 first. In other words, the user may step back and forth between steps 530 and 540, until the user is satisfied that all desired controls have been added, sized and positioned and defined by entering or editing their properties.

In step 550, the dialog properties and control properties are saved to the database 320. The saving of the dialog properties and control properties may occur at several different times. It is not important when the properties are saved to the database 320 so long as the properties are saved to the database 320 after the last change to the properties and prior to closing the dialog currently displayed in the design container 314. Those skilled in the art will appreciate that it is common to save information such as the properties any time the information has been changed and the editor or the item being edited is closed. It is the saved dialog and control properties which allow the dialog to be displayed when the dialog is used in the document development platform of the present invention.

FIG. 6 illustrates a flow diagram of an exemplary method 600 for implementing the principles of the software architecture of the template administrator 330, as shown in FIG. 3. In step 610, the template administrator 330 displays a dialog selector 312 and the user selects a dialog for use in designing a template.

In step 620, when the template administrator 330 receives the dialog selection, the template administrator 330 reads from the database 320 the name of any and all controls which are contained in the dialog. In step 630, the template administrator 330 displays a list, or the like, of bookmarks, preferably reflecting the names of the controls in the dialog.

In step 640, when the template administrator 330 receives the dialog selection, the template administrator 330 reads from the database 320 the name of any and all templates which have been associated with the dialog. The template administrator 330 then commands the native application 350 to display a template. If more than one template has been associated with the dialog, the template administrator 330 preferably commands only one template to be displayed by the native application 350. If more than one template has been associated with a dialog, the template administrator 330 presents the user with a template selector 336, which the user may use to switch between templates associated with the dialog.

In step 650, the user begins designing the template by selecting bookmarks from the bookmark list to insert into the template. When the template administrator 330 receives the user's selection of a bookmark to be inserted into the template, the template administrator 330 inserts the bookmark into the template.

In one embodiment, where the native application 350 does not display text at the position of a bookmark, the template administrator 330, in step 660, inserts the name of each bookmark at the position of the bookmark. This enables the user to see where the bookmark is positioned by seeing its name at that position.

The user may repeat step 650 until the user is finished inserting bookmarks into the template. In a preferred embodiment, the user may insert each bookmark into the template more than once.

In step 670, the user may format the template, including the positions of each bookmark, in any way the native application 350 allows. Those skilled in the art will appreciate that the user may perform steps 650 and 670 in any order and several times each while designing the template.

In one embodiment, in step 680, when the user is finished designing the template configuration, the user indicates this to the template administrator 330. The template administrator 330 deletes the name of the bookmark which the template administrator 330 had previously inserted into the template at each bookmark position to identify the bookmarks and their positions (but does not delete the bookmarks themselves) and commands the native application 350 to save the template. The template administrator 330 then closes. In a preferred embodiment, the user can command the template administrator 330 to save the template without closing the template administrator 330. In this embodiment, the template administrator 330 deletes the names of the bookmarks which the template administrator 330 had previously inserted into the template at the bookmark positions to identify the bookmarks and their positions (but not the bookmarks themselves) and commands the native application 350 to save the template. In this case, however, because the template administrator 330 is not being closed by the user, and the template is still displayed, the names of the bookmarks which the template administrator 330 deletes upon being ordered to save the template is deleted only from the copy saved to a storage device but is not deleted from the displayed copy of the template. Alternatively in this case, the template administrator 330 may delete the names of the bookmarks, save the template and reinsert the deleted names into the displayed template.

FIG. 7 illustrates a flow diagram of an exemplary method 700 for implementing the principles of the software architecture of the document generator 360, as shown in FIG. 3. In step 710, a template/DAT selector 362 is displayed by the document generator 360. In a preferred embodiment, the user may cause the template/DAT selector 362 to be displayed from within the native application 350, by, for example, selecting the “new” from a menu selection. Alternatively, the document generator 360 can be started as a standalone program which calls the native application 350 when the native application 350 is needed, as described below. In step 720, the user selects a DAT.

In step 730, upon receiving the user selection of a DAT, the document generator 360 reads the dialog and control properties from the database 320 and passes them to the dialog displayer 340. In step 740, the dialog displayer 340 reconstructs and displays the dialog as described above.

In step 750, the user interacts with the dialog. The user may interact with the dialog to achieve multiple purposes, including, but not limited to: insertion of text or other data into a control for the purpose of this text or other data being inserted into a document at a bookmark position for display in a generated document; selection of text or other data to be inserted into a document at a bookmark position for display in a generated document; selection of a template to be used by the dialog for inserting text or other data into a document at bookmark positions for display in a generated document based on that template Information which has been inserted into a control, or selected with a control, or which is contained in a label control is referred to herein as “control data”. When the user is done interacting with the dialog and desires a document to be generated, in step 760 the user indicates this, for example, by clicking an “OK” control to command the document generator 360 to generate a document.

In step 770, when the document generator 360 receives the command to generate a document, it commands the native application 350 to create a new document based on the template associated with the dialog.

In step 780, the document generator 360 searches the document for bookmarks, and for each bookmark, inserts the control data of the appropriate control, typically the control with the same name as the bookmark, into the document at the location of the bookmark and deletes the bookmark.

In step 790, the document generator 360 closes. The result of this exemplary method 700 for implementing the principles of the software architecture of the document generator 360 is a document which contains the information desired by the user to be contained therein, formatted in the manner the user desired and structured in the template when the user created the template in the template administrator 330.

The present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the DDS can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

1. A method of using a graphic user interface based document development system comprising the steps of:
designing a dialog;
associating a template with the dialog;
saving dialog and control properties to a database; and
designing the template.

2. The method of claim 1 where the step of designing a dialog is performed by a user without writing or compiling computer code.

3. The method of claim 1 where the step of associating a template with the dialog is performed by a user without writing or compiling computer code.

4. The method of claim 1 further comprising the steps of:
reading the dialog and control properties from the database; and
displaying the dialog.

5. The method of claim 4 further comprising the steps of:
entering data into at least one control of the dialog to form control data; and
inserting the control data into a document based on the template at a position marked by a bookmark.

6. The method of claim 5 where the bookmark has the same name as the control.

7. The method of claim 1 where the step of designing the template further comprises:
reading the names of controls from the database;
displaying the names as a list of bookmarks for user selection;
displaying the template; and
inserting at least one bookmark selected by a user into the template.

8. The method of claim 7 further comprising:
inserting a bookmark name into the template at the position of each bookmark; and
deleting each bookmark name from the template prior to saving the template.

9. A method of generating a document through a graphic user interface comprising the steps:
reading dialog and control properties from a database;
constructing a dialog based on the dialog and control properties;
displaying the dialog;
the user entering data into at least one control of the dialog to form control data; and
inserting the control data into a document, based on a template which has been associated to the dialog, at a position marked by a bookmark.

10. The method of claim 9 where the dialog is not stored as computer code.

11. The method of claim 9 where the step of entering data into a control comprises selecting data from a selection of data provided by the control to form control data.

12. The method of claim 9 where the template contains bookmarks corresponding to one or more controls of the dialog.

13. A graphic user interface based document development system comprising:
a graphic user interface based dialog designer configured to:
enable a user to design a dialog;
enable a user to configure dialog and control properties;
enable a user to associate at least one template with the dialog; and
save the dialog and control properties to a database.

14. The graphic user interface based document development system of claim 13 which is further configured to enable a user to design a dialog without writing or compiling computer code.

15. The graphic user interface based document development system of claim 13 which is further configured to enable a user to configure dialog and control properties without writing or compiling computer code.

16. The graphic user interface based document development system of claim 13 which is further configured to enable a user to associate at least one template with the dialog without writing or compiling computer code.

17. The document development system of claim 13 further comprising:
a graphic user interface based template administrator configured to enable a user to design a template by adding at least one bookmark to the template where the bookmark corresponds to a control in the dialog.

18. The document development system of claim 17 wherein the graphic user interface based template administrator is further configured to:
read control names contained in the dialog and a template name of the template associated to the dialog from a database;
open the template in a native application;
display a list of bookmarks corresponding to the control names; and
enable the user to insert at least one bookmark into the template.

19. The document development system of claim 17 where the graphic user interface based template administrator is further configured to:
insert a bookmark name into the template at the position of each bookmark; and
delete each bookmark name from the template prior to saving the template.

20. The graphic user interface based document development system of claim 13 further comprising a publisher configured to make a dialog and associated template available for use to end-users to generate a document.

21. The graphic user interface based document development system of claim 13 further comprising a document generator configured to:
read dialog and control properties from the database;
construct a dialog from the dialog and control properties;
display the dialog;
enable a user to enter information into or select information from controls contained in the dialog to form control data;
command a native application to create a document based on the template associated to the dialog; and
insert the control data into the document at bookmark positions, where each bookmark corresponds to a control in the dialog.

22. A program storage device or signals readable by a computer, tangibly embodying instructions executable by the computer to perform a method of enabling a user to operate a graphic user interface based document development system, the method comprising:
enabling the user to design a dialog;
enabling the user to associate a template with the dialog;
saving dialog and control properties to a database; and
enabling a user to design the template.

23. The program storage device or signals readable by a computer, tangibly embodying instructions executable by the computer to perform a method of enabling a user to operate a graphic user interface based document development system of claim 22 further comprising enabling the user to design a dialog without writing or compiling computer code.

24. The program storage device or signals readable by a computer, tangibly embodying instructions executable by the computer to perform a method of enabling a user to operate a graphic user interface based document development system of claim 22 further comprising enabling the user to associate a template with the dialog without writing or compiling computer code.

25. A program storage device or signals readable by a computer, tangibly embodying instructions executable by the computer to perform a method for enabling a user to generate a document through a graphic user interface, the method comprising:
reading dialog and control properties from a database;
constructing a dialog based on the dialog and control properties;
displaying the dialog;
enabling the user to enter data into at least one control of the dialog to form control data; and
enabling the user to insert the control data into a document, based on a template which has been associated to the dialog, at a position marked by a bookmark.
